(19) United States
(12) Patent Application Publication
(10) Pub. No.: US 2008/0159245 A1
(43) Pub. Date: Jul. 3, 2008

(54) Determination of a Network Identity for a Network Access Point

(75) Inventors: Howard P. Benn, Swindon (GB); Steven D. Vardy, Newbury (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/908,541

(22) PCT Filed: Mar. 27, 2006
(86) PCT No.: PCT/US2006/011144

§ 371 Date: Sep. 13, 2007

(30) Foreign Application Priority Data
Apr. 19, 2005 (GB) 0507841.5

(51) Int. Cl. H04Q 7/24

(52) U.S. Cl. 370/338

(57) ABSTRACT

An apparatus (101) for accessing an access point of a Wireless Local Area Network, (WLAN) comprises an access message generator (207) which generates encrypted probe messages that are encrypted in response to a plurality of test network identities. The access message generator (207) is coupled to a WLAN transceiver (203) which transmits the encrypted probe messages to an access point (113). The access point (113) decodes received access messages using a decryption key which depends on a network identity of the access point (113). If an encrypted probe message is successfully decrypted, a positive acknowledgement message is transmitted to the apparatus (101). This is received by the WLAN transceiver (203) and fed to an identity processor (211) which determines the network identity of the access point (113) as the test network identity of the encrypted probe message for which the positive acknowledgement message is received. The invention may be particularly suitable for interworking of WLAN and cellular communication systems.

### FIELD OF THE INVENTION

The invention relates to an apparatus for accessing an access point of a Wireless Local Area Network, WLAN, and to a method of determining an identity of an access point of a WLAN.

### BACKGROUND OF THE INVENTION

The use of wireless communication has become increasingly popular and widespread. For example, cellular communication systems have become ubiquitous and adoption rates approach a hundred percent in many regions.

In addition, Wireless Local Area Networks (WLANs) have become commonplace and is increasingly replacing wired networks as the preferred choice for many environments.

WLANs and cellular communication systems each provide specific advantages. Typically, cellular communication systems provide a much larger coverage area than WLANs which tend to be limited to hot spot areas. However, WLANs tend to provide improved data rates, Quality of Service and significantly reduced cost.

There is therefore an increasing interest in integrating the use of cellular communication systems and WLANs in order to utilise the individual advantages of each system. Accordingly, significant resource is currently invested in developing techniques, algorithms and standards for interworking cellular communication systems and WLANs.

For example, significant resource is invested in providing a seamless mobility where mobile terminals may seamlessly handover connections between cellular communication systems and WLANs. This may provide increased coverage, improved services and reduced cost. For example, when in the proximity of a WLAN access point, a mobile terminal may access a WLAN to obtain a high data rate service at a relatively low cost but may automatically handover to a cellular communication system when moving outside the coverage area of the WLAN.

However, WLANs and cellular communication systems have been developed independently and use very different techniques. For example, the underlying access principles used by WLANs and cellular communication systems are fundamentally different. Thus, in a WLAN system, access is initiated by a blind transmission of access messages from mobile terminals to an access point whereas in a cellular communication system, access messages are only transmitted in response to information received from the cellular network. This allows a more targeted and efficient access approach but increases complexity and resource requirements for the mobile terminal.

More specifically, a typical WLAN access process comprises the mobile terminal monitoring signal levels in the frequency band of the access point. If a signal level above a given threshold is detected, the mobile terminal transmits an access message. If the access message is successfully received, the access point transmits an acknowledge message to the mobile terminal and the access procedure for the mobile terminal is started. The access procedure then establishes all communication protocols, network and terminal identities etc. and thus includes substantial signalling between the mobile terminal and the network. Accordingly, each access procedure results in significant air interface communication and a large number of access procedures will result in a substantially increased interference.

In contrast, access procedures in cellular communication systems require the mobile terminal to receive and decode information transmitted from the base station before an access message is transmitted. Specifically, the mobile terminal typically monitors a broadcast channel to identify the network identity of the received broadcast channel. The broadcast channel specifically contains a Public Land Mobile Network (PLMN) code. The PLMN code is assigned by a central regulator and is unique for the individual cellular network. The cellular mobile terminal only accesses the cellular communication system if it is determined that the received network identity corresponds to a network which the mobile terminal is allowed to access. This substantially reduces the number of unsuccessful accesses and reduces the resource load.

WLAN systems such as IEEE 802.11.x networks do not prescribe broadcasting network identities and this may result in a large number of failed access attempts as the mobile terminal may attempt access to WLANs that are not connected to the right networks. In particular, when interworking between cellular systems and WLANs, a large number of access attempts may be made to WLAN access points that are not connected to the appropriate cellular network, thereby resulting in a substantial increase in interference and an increased power consumption of the mobile terminal.

In more detail, when interworking between a cellular communication system and a WLAN, the mobile terminal may detect a large signal level in the WLAN frequency band and may accordingly transmit an access request to an access point. However, as it is likely that only a small subset of access points will be connected to an appropriate cellular network, a large number of access requests will be transmitted which will initiate access procedures that will inevitably fail. Therefore, a large number of doomed access attempts may be made resulting in increased interference and power consumption and thus reduced battery life of the mobile terminal.

Accordingly, it is desirable to determine a network identity of a WLAN access point in connection with a WLAN access. This may allow the mobile terminal to only access the WLAN if it is connected to a suitable communication network as indicated by the network identity.

WLAN systems such as IEEE 802.11.x networks provide means for an access point to broadcast an access point name. Specifically, the access point transmits a Service Set IDentifier (SSID) which may be received by the mobile terminal. The SSID is a network name which may be freely chosen by an operator of the individual WLAN access point. It has been proposed that the SSID may include the network identity of a cellular communication network to which the WLAN is coupled. Specifically, it has been proposed that the SSID may be set to the PLMN identity of the cellular network.

However, the SSID is transmitted infrequently and unsynchronised. Typically, the SSID may only be transmitted with a time interval of 2 seconds. Accordingly, if a mobile terminal is required to receive and decode the SSID from an access point before making an access attempt, it must continuously monitor the broadcast signal. This requires additional receiver complexity and is very time consuming.

In particular, a mobile terminal attached to a cellular communication system allowing interworking with WLANs may receive a neighbour list that comprises WLAN access points. Accordingly, it must monitor for signal levels in the WLAN frequency band using WLAN receiver circuitry.

Furthermore, in order to determine the SSID (which is transmitted rarely and at an unknown time) the receiver must continuously be active. This results in a substantially increased power consumption and reduced battery life for the mobile terminal.

Hence, an improved system for determining a network identity for an access point of a WLAN would be advantageous and in particular a system allowing increased flexibility, improved performance, reduced complexity, faster detection and/or reduced power consumption would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for accessing an access point of a Wireless Local Area Network, WLAN, the apparatus comprising: generating means for generating an encrypted probe message encrypted in response to a test network identity; transmit means for transmitting the encrypted probe message to the access point; and determining means for determining a network identity for the access point in response to receiving a positive acknowledgement message for the encrypted probe message from the access point.

The invention may provide an improved way of determining a network identity for an access point thereby allowing an improved access procedure. In particular, the invention may allow a reduced number of unsuccessful access attempts e.g. resulting in reduced interference and/or reduced power consumption.

The invention is compatible with current standards and techniques used in most WLANs. An improved backwards compatibility may be achieved.

The invention may provide a fast and efficient way of determining a network identity. For example, the invention may avoid the necessity of decoding a SSID and may result in a reduced power consumption and/or complexity.

According to an optional feature of the invention, the determining means is arranged to determine the network identity as the test network identity if the positive acknowledgement message is received.

This provides for a practical and efficient way of determining a network identity and improves WLAN access.

According to an optional feature of the invention, the generating means is arranged to generate a plurality of encrypted probe messages encrypted in response to different test network identities; the transmitting means is arranged to transmit the plurality of encrypted probe messages; and the determining means is arranged to determine the network identity as the test network identity of an encrypted probe message of the plurality of encrypted probe messages for which the positive acknowledgement message is received.

The feature may allow an efficient detection of a network identity and may in particular allow a network identity out of a number of different network identities to be identified.

According to an optional feature of the invention, the apparatus further comprises access means for accessing the WLAN if the network identity corresponds to a network identity of a group of allowed network identities.

This may provide for an efficient access method. In particular, the apparatus may comprise an indication of which network identities can provide a required service and only if the detected network identity matches one of these identities is an access message transmitted. The allowed network identities may be stored in a local storage such as for example a Subscriber Identity Module (SIM).

According to an optional feature of the invention, the apparatus is a user equipment of a cellular communication system.

The user equipment may for example be a communication unit, a 3rd Generation User Equipment (UE), a subscriber unit, a mobile station, a communication terminal, a personal digital assistant, a laptop computer, an embedded communication processor or any physical, functional or logical communication element which is capable of communicating over the air interface of the cellular communication system. The invention may facilitate and/or improve interworking between cellular communication systems and WLANs.

The cellular communication system may for example be a second generation cellular communication system such as the Global System for Mobile communication GSM (including GPRS) or may be a 3rd generation cellular communication system such as the Universal Mobile Telecommunication System (UMTS).

According to an optional feature of the invention, the apparatus comprises handover means for performing a handover from the cellular communication system to the WLAN and the handover means is arranged to cause the transmit means to transmit the encrypted probe message. The apparatus may comprise functionality for performing handovers between a cellular communication system and a WLAN by determining a network identity of the WLAN from transmission of encrypted probe messages.

The feature may allow improved interworking and handover performance and may in particular allow reduced complexity, power consumption, handover delay and/or interference.

According to an optional feature of the invention, the test network identity is a network identity of a cellular communication network. This may allow improved interworking between a cellular communication system and a WLAN.

According to an optional feature of the invention, the cellular communication network is a home network of the user equipment. This may allow improved interworking and may in particular allow an efficient method of determining if a WLAN access point is suitable for a handover from a cellular communication system.

According to an optional feature of the invention, the encrypted probe message is encrypted in response to a Public Land Mobile Network, PLMN, identity of the cellular communication network.

This may provide for a particularly advantageous network identity determination and may improve backwards compatibility.

According to an optional feature of the invention, the apparatus comprises a list of preferred networks and the test network identity is selected from the list of preferred networks.

This may allow improved interworking and may in particular allow an efficient method of determining if a WLAN access point is suitable for a handover from a cellular communication system.

The list of preferred networks may for example comprise a list of preferred cellular communication networks which the user equipment may access to effect communication. For example, the list of preferred networks may comprise a list of cellular networks with which the operator of the user equipment's home network has roaming agreements. Thus, the list of preferred networks may correspond to a white list of networks listing all networks that can be used by the user equipment.

According to an optional feature of the invention, the list of preferred networks is comprised in a Subscriber Identity Module, SIM, of the cellular communication system.

This provides a particularly advantageous implementation and provides improved backwards compatibility and practicality.

According to an optional feature of the invention, the encrypted probe message is encrypted according to a Wired Equivalent Privacy, WEP, algorithm.

The encryption of the encrypted probe message may be in response to a WEP key. This may provide efficient performance and improved backwards compatibility and practicality.

According to an optional feature of the invention, a first part of an encryption key used for encrypting the encrypted probe message comprises a binary network identity.

This allows an advantageous and practical implementation. The encryption key may for example be a WEP key wherein at least some bits are determined in response to the test network identity. Specifically, the first part may comprise a binary PLMN code. For example, a 24 bit PLMN identity may be used as part of a 128 bit WEP encryption key.

According to an optional feature of the invention, a second part of the encryption key comprises a reduced encryption key. This may allow improved security and may allow an additional encryption function.

According to an optional feature of the invention, the WLAN is an Institute of Electrical and Electronic Engineers, IEEE 802 WLAN.

The WLAN may for example be an IEEE 802.11a, IEEE 802.11b, IEEE 802.11g or IEEE 802.11n WLAN as standardised by the Institute of Electrical and Electronic Engineers.

According to a second aspect of the invention, there is provided a method of determining an identity of an access point access point of a Wireless Local Area Network, WLAN, the method comprising: generating an encrypted probe message encrypted in response to a test network identity; transmitting the encrypted probe message to the access point; determining a network identity for the access point in response to receiving a positive acknowledgement message for the encrypted probe message from the access point.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a communication system comprising a user equipment in accordance with some embodiments of the invention;

FIG. 2 illustrates a simplified block diagram of a user equipment in accordance with some embodiments of the invention; and

FIG. 3 illustrates a flow chart of a method of determining a network identity for an access point of a Wireless Local Area Network in accordance with some embodiments of the invention.

### DETAILED DESCRIPTION OF EMBODIMENTS OF THE INVENTION

The following description focuses on embodiments of the invention applicable to a system comprising interworking functionality between a cellular communication system and a WLAN. In particular, the embodiments will primarily be described with reference to a user equipment of a cellular communication system which also comprises functionality for accessing WLANs. Furthermore, the cellular communication system is coupled to one or more WLANs and provides functionality for handover of ongoing communications between the WLAN and the cellular communication system.

However, it will be appreciated that the invention is not limited to this application but may be applied to many other communication systems including for example WLAN only communication networks.

In the specific example, the cellular communication system is a UMTS cellular communication system and the WLAN is an IEEE 802.11x WLAN such as an IEEE 802.11a WLAN.

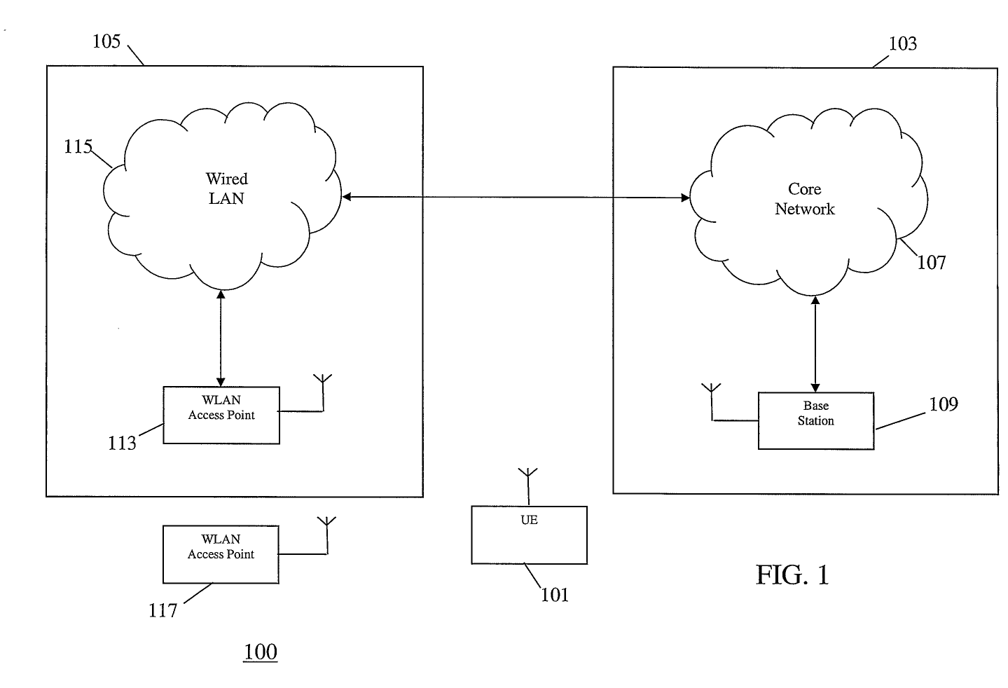

FIG. 1 illustrates a communication system comprising a user equipment in accordance with some embodiments of the invention.

In the example, the user equipment 101 is a user equipment of a cellular communication system. Furthermore, the user equipment 101 comprises functionality for communicating with WLAN systems.

In the example of FIG. 1 the cellular communication system comprises both a cellular communication network 103 and a WLAN 105. The cellular communication network 103 and a WLAN 105 and coupled together thereby allowing data to be routed from one system to the other.

The cellular communication network comprises a core network 107 which is coupled to a number of base stations of which one base station 109 is shown. The WLAN 105 comprises a number of access points of which one access point 113 is shown. The access point 113 is in the example coupled to a wired Local Area Network (LAN) 115. The wired LAN 115 is coupled to the core network 107 by Interworking functions (not shown).

FIG. 1 furthermore illustrates a WLAN access point 117 which is not coupled to the cellular communication network 103. Rather, the WLAN access point 117 may be a proprietary access point or may for example be an independent public access point providing e.g. Internet access.

In the system of FIG. 1, an integration of the WLAN 105 and the cellular communication network 103 is achieved wherein the user equipment 101 may support a given service through the cellular communication network 103 or the WLAN 105. Furthermore, the system provides seamless handover between the cellular communication network 103 and the WLAN 105. Thus, a given application of the user equipment 101 may be supported by communication through the cellular communication network 103 or by communication through the cellular communication network 103 depending on which system is the optimal system for the current conditions.

For example, the user equipment 101 may set up an Internet browsing service on the cellular communication network 103. The cellular communication network 103 may transmit a neighbour list to the user equipment 101 which comprises neighbouring cellular base stations as well as close by WLAN access points. The neighbour list may specifically include access point 113. Accordingly, the user equipment 101 may measure signal levels in the frequency band of access point 113. If a sufficiently high signal level is detected, it may transmit an access message to the access point 113. The access point 113 transmits an acknowledgement message and the user equipment 101 may proceed by setting up a connection to the WLAN 105 and supporting the Internet browsing through the WLAN 105.

Specifically, the data from or to the user equipment 101 may be routed between the cellular communication network 103 and the user equipment 101 through the WLAN 105. This may be particularly useful for e.g. voice services, such as Voice Over IP (VOIP) services.

However, it will be appreciated that in some embodiments, the WLAN 105 is not necessarily coupled to the cellular communication network 103 but may be directly coupled to a given destination. For example, Internet access may be provided to the user equipment 101 through the WLAN 105 by a direct coupling of the WLAN to the Internet.

Seamless handover between a cellular communication system and a WLAN may improve performance and provide a more efficient resource utilisation. However, for optimal performance it is essential that the interworking between the WLAN 105 and the cellular communication network 103 functions smoothly and efficiently. However, the access procedures for a conventional WLAN system are substantially different than for a cellular communication system.

In particular, cellular communication systems allow the user equipment to determine the identity of a neighbour base station before accessing the base, thereby allowing a targeted access process where accesses are only attempted to appropriate base stations.

However, conventional WLAN accesses are typically based on a simple signal level measurement. Thus, if the access point 113 and access point 117 use the same frequency spectrum, the user equipment 101 cannot differentiate between them without initiating a full access process. This leads to a significant increase in the number of failed access attempts resulting in increased interference and increased power consumption.

WLAN systems such as IEEE 802.11a provide functionality for access points to transmit an access point name in the form of an SSID. However, this is transmitted infrequently and requires a dedicated and continuously active receiver thereby resulting in increased delay, an inefficient access process, increased power consumption and increased complexity.

The system of FIG. 1 provides an efficient way of determining a network identity associated with the WLAN 105. The user equipment 101 may accordingly determine the network identity of the system it is attempting to access and may proceed only if the network identity is suitable.

Specifically, the system allows the user equipment 101 to transmit encrypted probe messages which are encrypted in accordance with test network identities. The access points may furthermore be arranged to decrypt access messages using a decryption algorithm which depends on the network identity of the corresponding WLAN 105. Thus, only access messages which are encrypted with the network identity of the WLAN 105 will be acknowledged by the access point 113 and all other access messages will be ignored. If the user equipment 101 receives an acknowledgement, this indicates that it has attempted to access WLAN 105 and it will accordingly proceed with setting up a connection to this WLAN 105.

As an example, the user equipment 101 may know the network identity of the WLAN 105 (e.g. provided through the neighbour list received from the cellular communication network 103). Upon detecting a sufficiently high signal level in the WLAN frequency band, the user equipment 101 may transmit the encrypted probe message encoded according to the known network identity for WLAN 105. If the nearby access point is indeed access point 113, this will successfully decrypt the encrypted probe message and will in response transmit a positive acknowledgment. The user equipment 101 is accordingly aware that it has accessed the appropriate WLAN and the setup procedure may continue.

However, if the high signal level were due to the user equipment 101 being in the proximity of access point 117, the transmitted encrypted probe message would not be decrypted by the access point 117. Accordingly, no positive acknowledgement process would be transmitted (in some embodiments no acknowledgement may be transmitted and in other embodiments a negative acknowledgement may e.g. be transmitted) and the user equipment 101 would not proceed with the setup process.

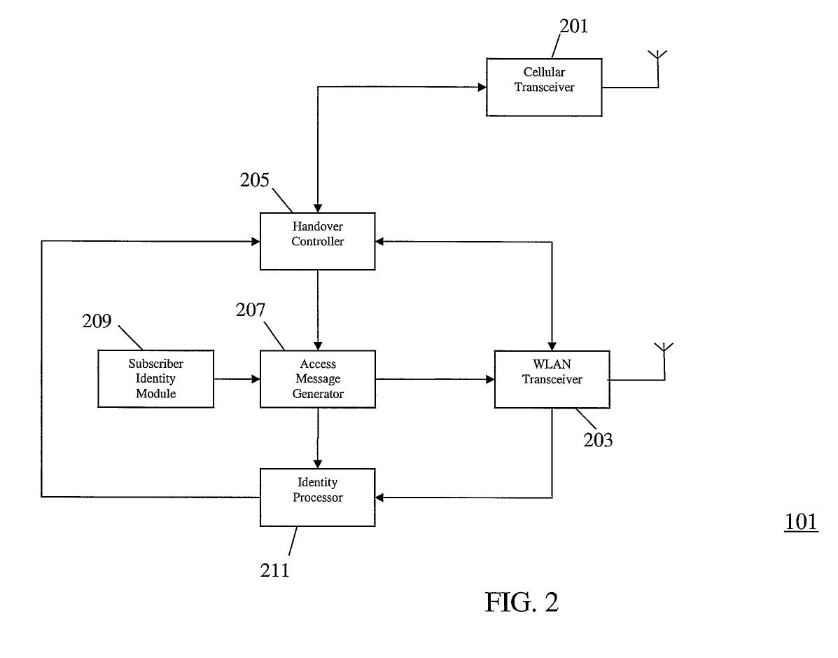

FIG. 2 illustrates a simplified block diagram of a user equipment in accordance with some embodiments of the invention. The user equipment may specifically be the user equipment 101 of FIG. 1 and will be described with reference to this.

The user equipment 101 comprises a cellular transceiver 201 which is operable to transmit and receive data over the air interface of the cellular communication system in accordance with the Technical Specifications of the cellular communication system. In the specific example, the cellular transceiver 201 is capable of communicating over the air interface in accordance with the UMTS Technical Specifications standardised by the 3^{rd} Generation Partnership Project (3GPP).

The user equipment 101 also comprises a WLAN transceiver 203 which is operable to communicate with WLAN access points in accordance with the Technical Specifications of the WLAN. In the specific example, the WLAN transceiver 203 is capable of communicating over the air interface in accordance with the IEEE 802.11a Technical Specifications standardised by the Institute of Electrical and Electronic Engineers.

The cellular transceiver 201 and the WLAN transceiver 203 are coupled to a handover controller 205 which controls the handover operation of the user equipment 101. In particular, the handover controller 205 is capable of receiving handover information from the cellular communication network 103 or the WLAN 105 and to control the cellular transceiver 201 and the WLAN transceiver 203 to perform measurements. Thus, the handover controller 205 may receive a neighbour list from the cellular transceiver 201 and may control both the cellular transceiver 201 and the WLAN transceiver 203 to make signal measurements for the neighbours of the neighbour list.

If the handover controller 205 receives information from the WLAN transceiver 203 indicating a high signal level in a frequency channel of a WLAN neighbour access point, it may determine that a handover to a WLAN system is possible and should be initiated. However, as WLAN frequency channels may be used by different WLAN systems and access points, a high signal level may be caused by the neighbour WLAN of the neighbour list or may be due to transmissions from another access point. Accordingly, the handover controller 205 initiates a handover process wherein a network identity of the access point is determined.

The handover controller 205 is coupled to an access message generator 207 which is arranged to generate at least one encrypted probe message that may be transmitted by the WLAN transceiver 203.

In the specific embodiment of FIG. 1, the access message generator 207 generates a plurality of different encrypted probe messages each of which is encrypted in response to a different network identity.

Specifically, the access message generator 207 is in the embodiment of FIG. 1 coupled to a Subscriber Identity Module (SIM) 209. The SIM 209 comprises a list of networks which may support the user equipment 101.

Specifically, the SIM 209 may comprise a white list which indicates the PLMN code of cellular communication networks which may support the user equipment 101. The white list may for example comprise the PLMN of networks for which the operator of the subscriber's home network have established roaming agreements. In addition, the SIM may comprise the home communication network PLMN identity.

In the example of FIG. 1, the access message generator 207 first selects the PLMN of the home network and generates an encrypted probe message in response thereto. This encrypted probe message is then used to detect if the access point has a network identity matching that of the home network as will be described below. If not, the access message generator 207 proceeds to sequentially select the PLMNs of the white list of the SIM 209. For each PLMN, an encrypted probe message is generated and used to check if the network identity of the access point matches.

Thus, a SIM comprising an indication of cellular communication networks that may support a user equipment may additionally be used for determining if a WLAN access points can successfully support the user equipment.

The access message generator 207 generates the encrypted probe message by applying a predetermined encryption algorithm to a standard access message. The encryption depends on the current test network identity.

In particular, the access message generator 207 may generate the encrypted probe message by applying a WEP encryption algorithm using a WEP key which is determined in response to the current test network identity. Specifically, the WEP key may comprise the PLMN code retrieved from the SIM 209. As a specific example, the access message generator 207 may use a 128 bit WEP key wherein the first 24 bits are set to the 24 bits of the PLMN currently being tested. The remaining bits may be set to zero or may be used to provide additional encryption functions. For example, in some embodiments the remaining bits of the WEP key may be set to a predetermined pattern which is not publicly available.

The access message generator 207 is coupled to the WLAN transceiver 203 and feeds the encrypted probe message to the WLAN transceiver 203 for transmission. The WLAN transceiver 203 transmits the encrypted probe message to the access point.

The access point 113 is set up to decrypt all received access messages using an encryption key that depends on a network identity associated with the access point. For example, the access point 113 may use a network identity of the WLAN and decrypt all access messages using a decryption key derived in response thereto. This may be useful in embodiments where the WLAN 105 is operated independently of the cellular communication system 103 and the network identity may in the example be communicated to the user equipment 101 in connection with the neighbour list.

In other embodiments, the network identity of the access point 113 may be the network identity of the cellular communication network to which the WLAN is coupled. This may be particularly advantageous in embodiments where the WLAN is provided by the operator of the corresponding cellular communication network. It may further facilitate operation as the user equipment 101 may use the cellular network information when determining whether to access the access point 113. In particular, it may simply use the information stored on a cellular SIM 209.

Thus, in some such embodiments, the access point 113 may simply decrypt all received access messages using a 128 bit WEP key wherein the first 24 bits are set to the 24 bit PLMN of the cellular communication network 103 and the remaining bits are set to zero.

If the access point 113 receives an access message encrypted with the appropriate WEP key, it will successfully decrypt the access message and will accordingly transmit a positive acknowledge message back to the user equipment 101. However, if the access point 113 receives an access message which is not encrypted or is encrypted with a different WEP key, no positive acknowledgement message is transmitted.

Other access points, such as access point 117, receiving an encrypted probe message from the user equipment 101 will not reply with a positive acknowledgement message unless the encrypted probe message is encrypted by the same key used by the access point. Thus, an access point which is not arranged to support the user equipment 101 will not return a positive acknowledgement message.

The WLAN transceiver 203 is coupled to an identity processor 211 which is operable to determine the network identity for the access point in response to receiving a positive acknowledgement message for the encrypted probe message from the access point.

Specifically, the WLAN transceiver 203 receives any positive acknowledgement message transmitted to the user equipment 101. These messages are passed to the identity processor 211 which correlates the acknowledgement message with the transmitted encrypted probe messages to determine the corresponding network identity. Hence, if an encrypted probe message is transmitted resulting in a positive acknowledgement message being received, the identity processor 211 determines that the network identity matches one of the identities of the white list and that accordingly the access point is capable of supporting the user equipment 101. This information is fed to the handover controller 205 which subsequently proceeds to perform a handover of the user equipment 101 from the cellular communication network 103 to the WLAN 105.

In typical WLAN systems, access messages are very short and the delay in transmitting a positive acknowledgement message is likewise very short. Thus, the entire process of transmitting an encrypted probe message and determining if this is positively acknowledged may be performed in a very short time interval—typically around 2 msec or less. Thus, the user equipment 101 may very quickly run through the white list and determine if the detected access point has a corresponding network identity. If so, a handover may be instigated but if no match is found any further handover process to the access point may be avoided. Accordingly, a very efficient system for determining a network identity of a WLAN access point is achieved. The described approach may substantially reduce the number of failed handover attempts and may reduce interference and power consumption. In addition, it is not necessary to continuously monitor transmissions from the access point and thus the complexity and resource use of the user equipment may be substantially reduced.

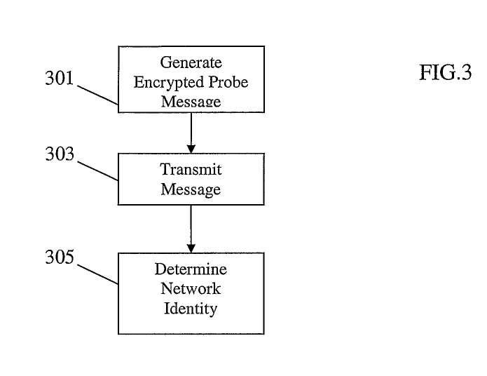

FIG. 3 illustrates a flow chart of a method of determining a network identity for an access point of a Wireless-Local Area Network in accordance with some embodiments of the invention.

The method initiates in step 301 wherein an encrypted probe message which is encrypted in response to a test network identity is generated. The encryption may for example be by use of an encryption key comprising the test network identity.

Step 301 is followed by step 303 wherein the encrypted probe message is transmitted to the access point.

Step 303 is followed by step 305 wherein it is determined if a positive acknowledgement message for the encrypted probe message is received from the access point.

If so, the network identity is determined as the test network identity. If no positive acknowledgement message is received it is determined that the network identity of the access point is not that of the test network identity.

Steps 301 to 303 may be iterated for a plurality of test network identities.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for accessing an access point of a Wireless Local Area Network, WLAN, the apparatus comprising:
generating means for generating an encrypted probe message encrypted in response to a test network identity;
transmit means for transmitting the encrypted probe message to the access point; and
determining means for determining a network identity for the access point in response to receiving a positive acknowledgement message for the encrypted probe message from the access point.

2. The apparatus of claim 1 wherein the determining means is arranged to determine the network identity as the test network identity if the positive acknowledgement message is received.

3. The apparatus of claim 1 wherein
the generating means is arranged to generate a plurality of encrypted probe messages encrypted in response to different test network identities;
the transmitting means is arranged to transmit the plurality of encrypted probe messages; and
the determining means is arranged to determine the network identity as the test network identity of an encrypted probe message of the plurality of encrypted probe messages for which the positive acknowledgement message is received.

4. The apparatus of claim 1 further comprising access means for accessing the WLAN if the network identity corresponds to a network identity of a group of allowed network identities.

5. The apparatus of claim 1 further comprising handover means for performing a handover from the cellular communication system to the WLAN and wherein the handover means is arranged to cause the transmit means to transmit the encrypted probe message.

6. The apparatus of claim 1 wherein the encrypted probe message is encrypted in response to a Public Land Mobile Network, PLMN, identity of the cellular communication network, and wherein the apparatus comprises a list of preferred networks comprised in a Subscriber Identity Module (SIM) of the cellular communication system, and wherein the test network identity is selected from the list of preferred networks.

7. The apparatus of claim 1 wherein the encrypted probe message is encrypted according to a Wired Equivalent Privacy (WEP) algorithm.

8. The apparatus of claim 1 wherein a first part of an encryption key used for encrypting the encrypted probe message comprises a binary network identity.

9. The apparatus of claim 9 wherein a second part of the encryption key comprises a reduced encryption key.

10. A method of determining an identity of an access point of a Wireless Local Area Network, WLAN, the method comprising:
generating an encrypted probe message encrypted in response to a test network identity;
transmitting the encrypted probe message to the access point;
determining a network identity for the access point in response to receiving a positive acknowledgement message for the encrypted probe message from the access point.
